(19) United States
(12) Patent Application Publication
(10) Pub. No.: US 2013/0232451 A1
(43) Pub. Date: Sep. 5, 2013

(54) ELECTRONIC DEVICE AND METHOD FOR SWITCHING BETWEEN APPLICATIONS

(71) Applicant: CHI MEI COMMUNICATION SYSTEMS, INC., New Taipei (TW)

(72) Inventors: YU-CHEN CHEN, New Taipei (TW); MING-CHIH LIN, New Taipei (TW)

(73) Assignee: CHI MEI COMMUNICATION SYSTEMS, INC., New Taipei (TW)

(21) Appl. No.: 13/747,592

(22) Filed: Jan. 23, 2013

(30) Foreign Application Priority Data
Mar. 1, 2012 (TW) 101106838

(51) Int. Cl. G06F 3/0488

(52) U.S. Cl. CPC G06F 3/0488
USPC 715/835

(57) ABSTRACT

In a method for switching between applications of an electronic device, a switch mode and an activation condition of the switch mode are set. The method displays a switch menu on a current user interface when the switch mode is activated, the switch menu includes icons of running applications of the electronic device. The method determines a selected icon in response to receiving a touch signal on the selected icon in the switch menu, and determines one of the running applications corresponding to the selected icon. The current user interface is switched to a software interface of the determined running application.

### BACKGROUND

1. Technical Field

Embodiments of the present disclosure relate to application program managements technology, and particularly to an electronic device and method for switching between applications using the electronic device.

2. Description of Related Art

When a plurality of applications are running simultaneously in an electronic device having a touch panel, a user needs to switch between the running applications using a keystroke (e.g., a physical key or a virtual key) of the electronic device. Otherwise, the user has to close a current application and then select another application. Thus, it is inefficient for the user to switch between multiple applications. Therefore, an efficient method for switching between applications using the electronic device is desired.

### BRIEF DESCRIPTION OF THE DRAWINGS

FIG. 1 is a schematic diagram of one embodiment of an electronic device including a switching system.

FIG. 2 is a schematic diagram of function modules of the switching system in the electronic device.

FIG. 3 is a schematic diagram of one embodiment of a switch menu provided by the switching system.

FIG. 4 is a flowchart of one embodiment of a method for switching between applications using the switching system.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

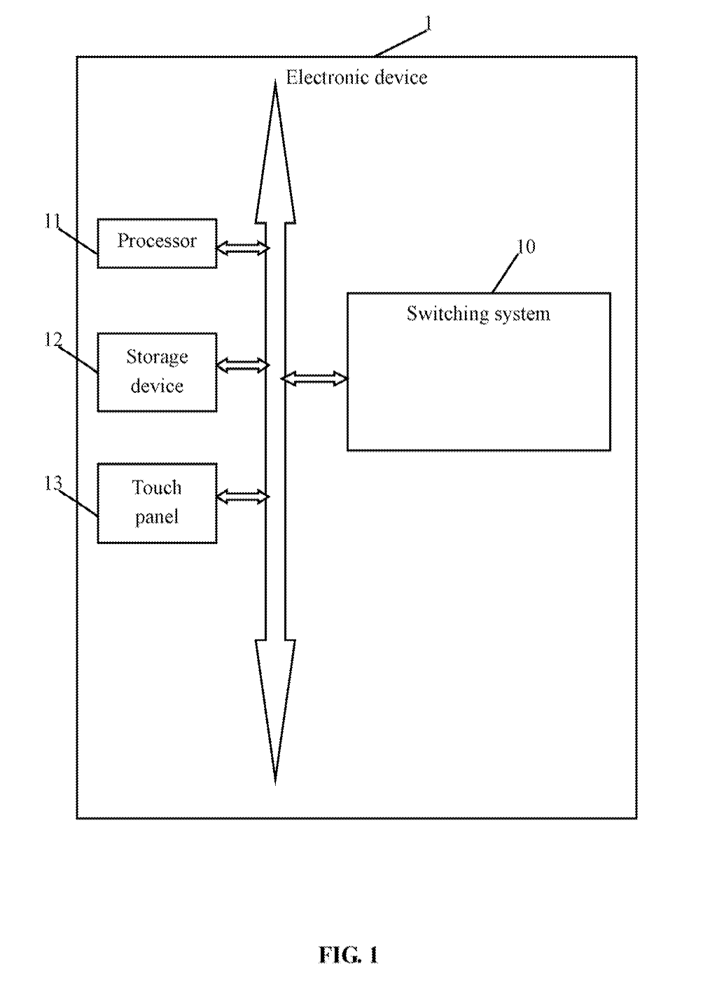

FIG. 1 is a block diagram of one embodiment of an electronic device 1 including a switching system 10. The electronic device 1 further includes at least one processor 11, a storage device 12, and a touch panel 13. FIG. 1 illustrates only one example of the electronic device 1 that may include more or fewer components than illustrated, or have a different configuration of the various components in other embodiments.

The switching system 10 is used to switch between running applications of the electronic device 1. A detailed description of the switching system 10 will be given in the following paragraphs.

In one embodiment, the electronic device 1 may be a mobile phone, a tablet computer, a personal digital assistant, a notebook computer, or any other device. In one embodiment, the switching system 10 may include computerized instructions in the form of one or more programs that are executed by the at least one processor 11 and stored in the storage device 12. The storage device 12 stores one or more programs, such as operating systems, applications of the electronic device 1, and various kinds of data, such as images. In some embodiments, the storage device 12 may be an external storage card, such as a memory stick, a smart media card, a compact flash card, a secure digital card, or any other type of memory storage device. The touch panel 13 may display data in visible form, such as images, and receive user operations on the touch panel 13.

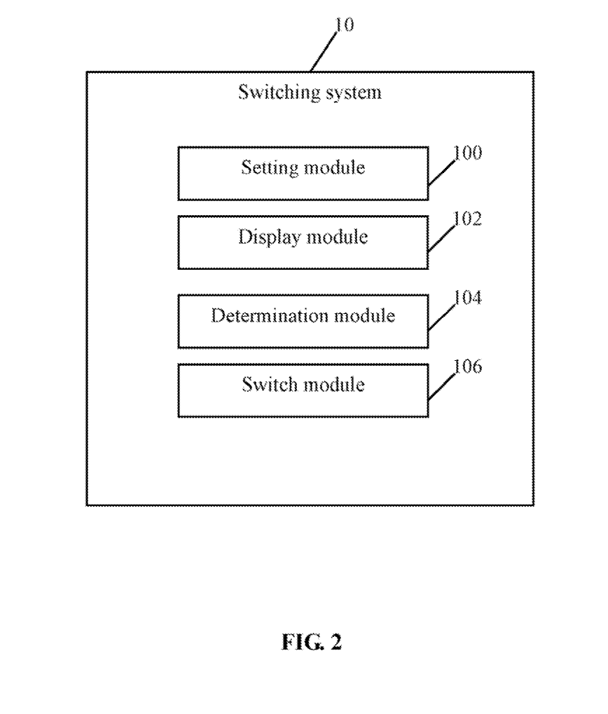

FIG. 2 is a block diagram of function modules of the switching system 10 included in the electronic device 1. In one embodiment, the switching system 10 may include one or more modules, for example, a setting module 100, a display module 102, a determination module 104, and a switch module 106. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

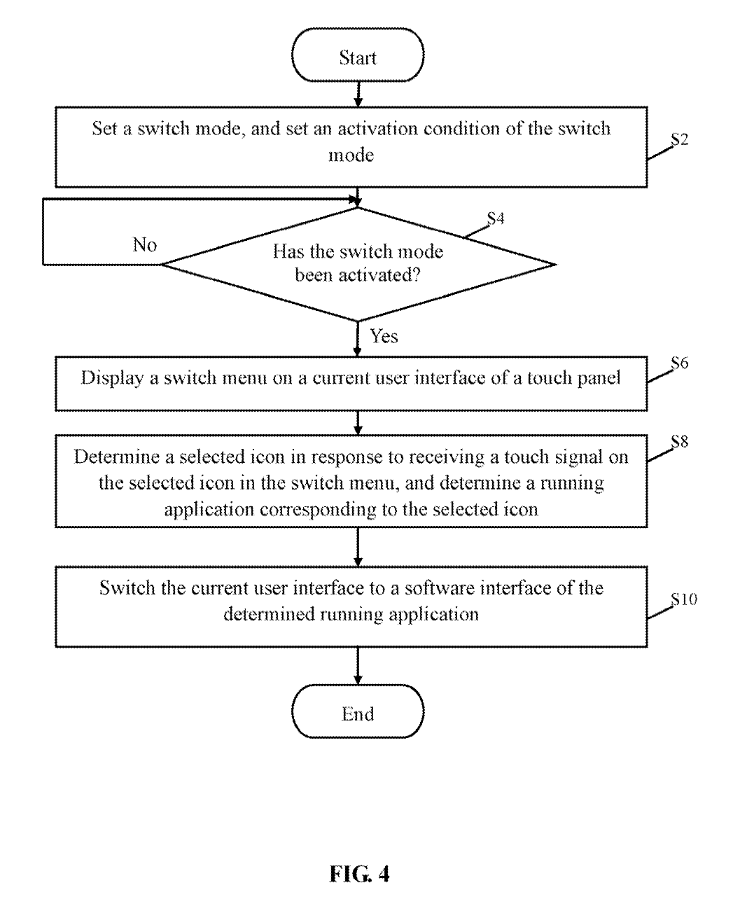

FIG. 4 is a flowchart of one embodiment of a method for switching between applications using the switching system 10. Depending on the embodiment, additional steps may be added, others removed, and the ordering of the steps may be changed.

In step S2, the setting module 100 sets a switch mode, and sets an activation condition of the switch mode. In some embodiments, the switch mode is activated when the activation condition is triggered, and the activation condition is a one-touch operation or a multi-touch operation carried out on the touch panel for a predetermined time period (e.g., 5 seconds).

In step S4, the display module 102 determines whether the switch mode has been activated by determining whether the activation condition is triggered. When the activation condition is triggered, the switch mode is activated. If the switch mode is not activated, step S4 is repeated.

For example, when a user of the electronic device 1 touches/taps/clicks/drags/slides on the touch panel 13 using a single finger (or a stylus) for the predetermined time period, that is, the one-touch operation is executed by the user, the display module 102 receives a one-touch signal, determines the switch mode is activated, and displays the switch menu on the touch panel 13.

For another example, the user may touch/tap/click/drag/slide on the touch panel 13 using at least two single fingers (or styluses) for the predetermined time period, that is, when the multi-touch operation is executed by the user, the display module 102 receives a multi-touch signal, determines that the switch mode is activated, and displays the switch menu on the touch panel 13.

In other embodiments, the activation condition may be a predetermined gesture to be implemented on the touch panel 13. For example, the predetermined gesture may be implemented by drawing a figure (e.g., a circle) on the touch panel 13, or by completing predetermined operations (e.g., tapping the touch panel 13 three times), or by clicking a preset hotkey.

If the switch mode is activated, in step S6, the display module 102 displays a switch menu on a current user interface of the touch panel 13. The switch menu includes icons of running applications of the electronic device. In some embodiments, the current user interface is a desktop of the electronic device 1, or a software interface of one of the running applications.

In some embodiments, a format, display contents, a display mode and a display position of the switch menu may be preset by the setting module 100. The display position of the switch menu may be changed according to a drag operation of the user. In some embodiments, the display position of the switch menu may be a position near to a tapped/pressed position implemented by the user. For example, a distance between the display position of the switch menu and the tapped/pressed position may be 1 centimeter.

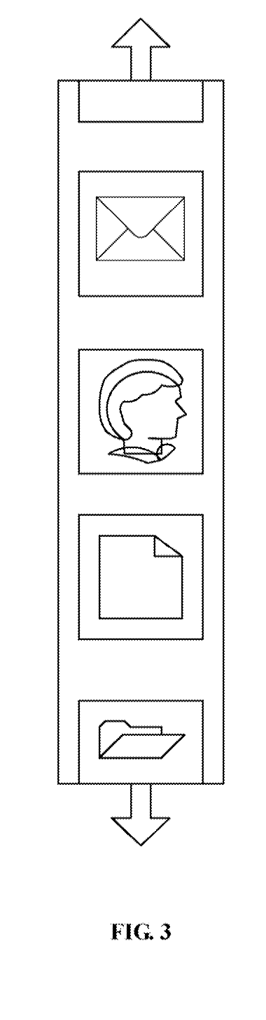

The display mode of the switch menu also may be changed by recognizing another specified gesture that is different from the above mentioned predetermined gesture. For example, when the user slides his finger up and down on the touch panel 13, the icons in the switch menu may be arranged vertically. As shown in FIG. 3, the icons are arranged vertically. For another example, when the user slides his finger on the touch panel 13 horizontally from left to right, the icons in the switch menu may be displayed horizontally from left and right.

The icons in the switch menu may be scrolled up, scrolled down, scrolled left, or scrolled right according to a slide operation received by the electronic device 1. For example, when the user presses the touch panel 13 using two fingers for the predetermined time period, the switch mode is activated. Then when the user slides one finger on the touch panel 13, the display module 102 displays the icons in the switch menu vertically as shown in FIG. 3. Furthermore, the user may scroll through the switch menu to select a desired icon to enter a specified running application.

In some embodiments, the display module 104 displays the switch menu on the current user interface by: determining the running applications of the electronic device, and appending the icons of the running applications into the switch menu. In some embodiments, the running applications represent applications which are already running in the electronic device 1. The display module 104 further determines an icon corresponding to a closed application when one of the running applications has been closed, and removes the determined icon from the switch menu.

When there is only one running application in the electronic device 1, the display module 102 may output a prompt to prompt that there is no need to switch between the applications.

In step S8, the determination module 104 determines a selected icon in response to receiving a touch signal on the selected icon in the switch menu, and determines which one of the running applications corresponds to the selected icon.

In step S10, the switch module 106 switches the current user interface to a software interface of the determined running application

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for switching between applications using an electronic device, the electronic device comprising a touch panel, the method comprising:
setting a switch mode, and setting an activation condition of the switch mode;
displaying a switch menu on a current user interface of the touch panel when the switch mode is activated, the switch menu comprising icons of running applications of the electronic device;
determining a selected icon in response to receiving a touch signal on the selected icon in the switch menu, and determining one of the running applications corresponding to the selected icon; and
switching the current user interface to a software interface of the determined running application.

2. The method according to claim 1, wherein the switch mode is activated when the activation condition is triggered, and the activation condition is a one-touch operation or a multi-touch operation carried out on the touch panel for a predetermined time period.

3. The method according to claim 1, further comprising:
setting a display position of the switch menu on the touch panel.

4. The method according to claim 1, wherein the step of displaying a switch menu on a current user interface of the touch panel when the switch mode is activated comprises:
determining the running applications of the electronic device;
appending the icons of the running applications into the switch menu; or
determining an icon corresponding to a closed application when one of the running applications is closed, and removing the determined icon from the switch menu.

5. The method according to claim 1, wherein the icons in the switch menu are scrolled up, scrolled down, scrolled left, or scrolled right according to a slide operation received by the electronic device.

6. The method according to claim 1, wherein the current user interface is a desktop of the electronic device, or a software interface of one of the running applications.

7. An electronic device, comprising:
a touch panel;
a storage device;
at least one processor; and
one or more modules that are stored in the storage device and are executed by the at least one processor, the one or more modules comprising:
a setting module that sets a switch mode, and setting an activation condition of the switch mode;
a display module that displays a switch menu on a current user interface of the touch panel when the switch mode is activated, the switch menu comprising icons of running applications of the electronic device;
a determination module that determines a selected icon in response to receiving a touch signal on the selected icon in the switch menu, and determines one of the running applications corresponding to the selected icon; and
a switch module that switches the current user interface to a software interface of the determined running application.

8. The electronic device according to claim 7, wherein the switch mode is activated when the activation condition is triggered, and the activation condition is a one-touch operation or a multi-touch operation carried out on the touch panel for a predetermined time period.

9. The electronic device according to claim 7, wherein the setting module further sets a display position of the switch menu on the touch panel.

10. The electronic device according to claim 7, wherein the display modules displays the switch menu on the current user interface by:
determining the running applications of the electronic device;
appending the icons of the running applications into the switch menu; or
determining an icon corresponding to a closed application when one of the running applications is closed, and removing the determined icon from the switch menu.

11. The electronic device according to claim 7, wherein the icons in the switch menu are scrolled up, scrolled down, scrolled left, or scrolled right according to a slide operation received by the electronic device.

12. The electronic device according to claim 7, wherein the current user interface is a desktop of the electronic device, or a software interface of one of the running applications.

13. A non-transitory storage medium having stored thereon instructions that, when executed by a processor of an electronic device, causes the electronic device to perform a method for switching between applications using the electronic device, the electronic device comprising a touch panel, the method comprising:
setting a switch mode, and setting an activation condition of the switch mode;
displaying a switch menu on a current user interface of the touch panel when the switch mode is activated, the switch menu comprising icons of running applications of the electronic device;
determining a selected icon in response to receiving a touch signal on the selected icon in the switch menu, and determining one of the running applications corresponding to the selected icon; and
switching the current user interface to a software interface of the determined running application.

14. The non-transitory storage medium according to claim 13, wherein the switch mode is activated when the activation condition is triggered, and the activation condition is a one-touch operation or a multi-touch operation carried out on the touch panel for a predetermined time period.

15. The non-transitory storage medium according to claim 13, wherein the method further comprises:
setting a display position of the switch menu on the touch panel.

16. The non-transitory storage medium according to claim 13, wherein the step of displaying a switch menu on a current user interface of the touch panel when the switch mode is activated comprises:
determining the running applications of the electronic device;
appending the icons of the running applications into the switch menu; or
determining an icon corresponding to a closed application when one of the running applications is closed, and removing the determined icon from the switch menu.

17. The non-transitory storage medium according to claim 13, wherein the icons in the switch menu are scrolled up, scrolled down, scrolled left, or scrolled right according to a slide operation received by the electronic device.

18. The non-transitory storage medium according to claim 13, wherein the current user interface is a desktop of the electronic device, or a software interface of one of the running applications.
